(19) United States
(12) Patent Application Publication
(10) Pub. No.: US 2005/0193011 A1
(43) Pub. Date: Sep. 1, 2005

(54) System and method for integrating reservation information with personal information management

(75) Inventors: John Peebles, Parsippany, NJ (US); Robert Kost, Cortlandt Manor, NY (US); Sam Meo, Holmes, NY (US); David Levinson, New York, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Wizard Co., Inc., Las Vegas, NV (US)

(21) Appl. No.: 10/935,836

(22) Filed: Sep. 8, 2004

Related U.S. Application Data
(60) Provisional application No. 60/541,529, filed on Feb. 3, 2004.

(51) Int. Cl. G06F 17/00

(52) U.S. Cl. 707/104.1

(57) ABSTRACT

Methods, apparatus and systems coordinate reservation scheduling information of a reservation system with personal management/organizer application. A reservation coordinating module, preferably integrated with personal organizer application, is configured to provide a user with the ability to direct the creation, deletion, modification and viewing of reservations from the user's personal organizer application. The module communicates requests from a system on which the module is installed to the reservation system and receives responses therefrom. The module automates storing or modifying associated appointments in the data structure of the personal management application in conjunction with successful reservations creation/change operations communicated with the reservation system.

### CROSS-REFERENCE TO RELATED APPLICATIONS

The present application claims the benefit of U.S. provisional patent application Ser. No. 60/541,529, filed Feb. 3, 2004, the disclosure of which is incorporated herein by reference in its entirety.

### FIELD OF THE INVENTION

The present invention relates to reservation systems. More particularly the invention involves methods and apparatus for coordinating reservation scheduling information of a reservation service with scheduling information in a personal organizer application.

### BACKGROUND OF THE INVENTION

The prolific advancement of technology in the areas of portable computing and software has offered new opportunities for users to organize themselves with the assistance of advanced technology. In this regard, many portable devices and office and home computer systems provide scheduling software so that a user can track his or her availability in the office or on the go. For example, one widely available product is Microsoft™ Outlook™. This application, which is available both for computers and personal data assistants, includes a calendar feature allowing a user to enter and manage appointments. Many other applications for use on computer systems and personal data assistants alike have also been offered to provide this type of organizational functionality such as Lotus Notes™, Palm OS®, Act 2000™ and Netscape Messenger™.

However, along with increased functionality comes increased effort. In this regard, keeping an electronic scheduling application up-to-date requires work. Users desiring to make appointments need to diligently enter scheduling information into their own application in order for the application to be of any significant benefit. Moreover, as these appointments change, scheduling information must be modified otherwise it will be of no use to the user.

This is no less true, and perhaps even truer, for managing appointments which relate to third party services over which the user generally has little control. Consider a third party service that takes reservations for its services from a user such as an automobile rental service. It is often useful for an organized person to have information associated with a reservation with the third party service managed by the person's own scheduling application. Thus, when the user makes a reservation with the third party service, the user must enter an appointment in the user's personal scheduling application. If the reservation appointment needs to be changed by the user, the user must change the appointment with the third party service as well as in the user's own scheduling application. Similarly, if the appointment becomes unavailable or is changed at the third party service, the user must also make the change in the user's own scheduling application, when and if the user learns of the change.

Many reservation-related third party services, such as airlines or car rental services, have automated internet accessible web sites for allowing a user to enter a reservation request into the reservation systems of the third party service. In this arrangement, the user will access a website of the reservation service with a web/Internet browser running on the user's computer beginning by downloading the web pages, such as HTML text documents, associated with making or changing reservations. Once a new reservation request is approved by the reservation service and confirmed to the user through the browser, typically, the user is still required to manually enter the same information (either by hand or by importing a file into the calendar program) in his or her own scheduling application. Similarly, any changes made to the reservation through the browser by the user or the third party service typically require re-entry in the user's own scheduling application.

Such systems provide only an incomplete solution. A more convenient solution which can provide for a greater degree of coordination between reservations of a reservation system and the personal scheduling information of a user's scheduling application is still needed.

### SUMMARY OF THE INVENTION

The invention includes methods, devices and systems for coordinating scheduling information from a reservation system. In a preferred embodiment, the system and method for integrating car reservation information with personal information management information is provided. In one aspect, the system provides a processor, instructions and data at a first node of a network. The instructions include instructions for managing appointments and storing data associated with appointments. The network is preferably but not necessarily the Internet, the processor is preferably a component of a personal computer, and the instructions preferably comprise a component of a calendar program such as Microsoft Outlook. The system further comprises car reservation data stored at a second node of the network.

In operation, the appointment data and reservation data are synchronized such that when a reservation is created, at least a portion of the information associated with the reservation is stored at the first node as appointment data and also at the second node as reservation scheduling information (e.g., a car reservation). Modification of the synchronized data at the first node causes a change at both nodes, namely, both the appointment data and the reservation data. Modification of the synchronized data at the second node also causes a change at both nodes, namely both the appointment data and reservation data.

In one embodiment, a unique method coordinates the reservations of a reservation system with the scheduling information of a personal organizer running on a user's system by accessing a reservation coordinator routine or module for controlling a user's system. The reservation coordinator is configured on the user's system to enable a user to direct scheduling of reservations with a reservation system through a communications link from the user's system and further configured to store scheduling information of the reservation system in a personal organizer of the user's system. The reservation coordinator communicates through the communications link by sending a scheduling request for reserving a resource tracked by the reservation system which is initiated under the control of the reservation coordinator module in response to user input on the user's system. The module receives a reservation confirmation from the reservation system relating to the scheduling request through the communications link. The module then stores scheduling information of the reservation confirmation as an associated appointment in a personal organizer of the user's system under the control of the reservation coordinator module.

In another embodiment, a medium for storing processor control instructions for a computer or the like includes a reservation coordinator module with processor control instructions. The module includes a user interface with a prompt to enable a user to selectably initiate a request for a reservation to schedule resources managed by a reservation system. The user interface is preferably integratable with a personal organizer application that organizes scheduling information of a user with a calendar data structure. The medium also includes a create routine responsive to the user interface to send requests for reservations to the reservation system and to receive a confirmation with reservation scheduling information for available resources, which may be transmitted via an accessible communications device. Preferably, a store operation responsive to a confirmation response places reservation scheduling information of the reservation system in the calendar data structure of the personal organizer application as an associated appointment. In this way, the reservation coordinator enables a user of the personal organizer application running on a personal scheduling system to direct scheduling of resources of the reservation system from the personal organizer application and enables automating entry of the reservation scheduling information from the reservation system in the personal organizer application.

In still another embodiment, a system for controlling coordinating of reservation scheduling information includes a reservation system for managing and scheduling availability of resources of a reservation service for many users of the resources of the reservation service. The reservation system is accessible to a communications network to receive requests and send responses over the communications network relating to managing and scheduling of the resources. An integratable reservation coordinator module is distributed to users of the reservation system, each configured for integration with a personal organizer application of the users' personal scheduling systems which are also accessible to the communications network. The reservation coordinator module is configured with operations to enable the users of the personal organizer applications to direct coordination of reservations of the reservation system by communicating automated requests to the reservation system for creating or deleting reservations. These operations may be initiated with a user interface of the personal organizer application. The reservation coordinator module is also configured with automated operations to enter or remove appointments associated with reservations of the reservation system. These operations change the calendar data structure of the personal organizer application to coordinate any changes made in the reservation system in conjunction with requests made by the reservation coordinator module.

Additional aspects of the invention will be apparent from an understanding of the details contained in the detailed description.

### BRIEF DESCRIPTION OF THE DRAWINGS

For the purposes of illustrating the invention, there are shown in the drawings, forms that are presently preferred, it being understood, however, that the invention is not limited to the precise arrangements and instrumentalities shown.

FIG. 1 is a network diagram of an embodiment of a system of the invention;

FIG. 2 is a visual representation of the processes of an embodiment of the invention in the system of FIG. 1;

FIG. 3 illustrates a processor type personal scheduling system having a storage medium with control instructions including a personal organizer and reservation coordinator and a data structure for appointments of the personal organizer.

FIG. 4 is a user interface of a personal organizer application suitable for use in one embodiment of the invention;

FIG. 5 is a flow chart of a routine for coordinating and creating a reservation with a personal organizer and reservation system;

FIG. 6 is one embodiment of an interface used in creating a reservation;

FIG. 7 is one embodiment of another interface that may be utilized for creating a reservation in conjunction with a personal organizer application;

FIG. 8 is one embodiment of an interface for displaying available options with regard to the availability of the resources of a reservation system for creating a reservation with a personal organizer;

FIG. 9 is one embodiment of an interface for initiating communicating a request to create a reservation in a reservation system with respect to scheduling information of a personal organizer application;

FIG. 10 is a flow chart of one embodiment of a routine for viewing and coordinating a reservation of a reservation system with a personal organizer;

FIG. 11 is one embodiment of an interface for viewing a reservation of a reservation system relating to an associated appointment of a personal organizer with cancel and modify input prompts or buttons to cancel or modify a viewed reservation;

FIG. 12 is a flow chart of one embodiment of a routine for canceling a reservation of a reservation system and coordinating it with a personal organizer;

FIG. 13 is a flow chart of one embodiment of a routine for modifying a reservation of a reservation system and coordinating it with a personal organizer.

### DETAILED DESCRIPTION

The invention generally involves a methodology for synchronizing reservation information of a third party reservation service such as an automobile rental reservation service, an airline reservation service or the like. The methodology permits the reservation information to be uniquely coordinated with associated scheduling information in an organizer of the user of the reservation service. Scheduling information may include the date and time of the reservation and a description of the reservation (e.g., the name of the reservation service, the name of the user reserving the service, the details of what has been reserved, pickup time and date, drop off time and date, a reservation confirmation number or identifier etc.)

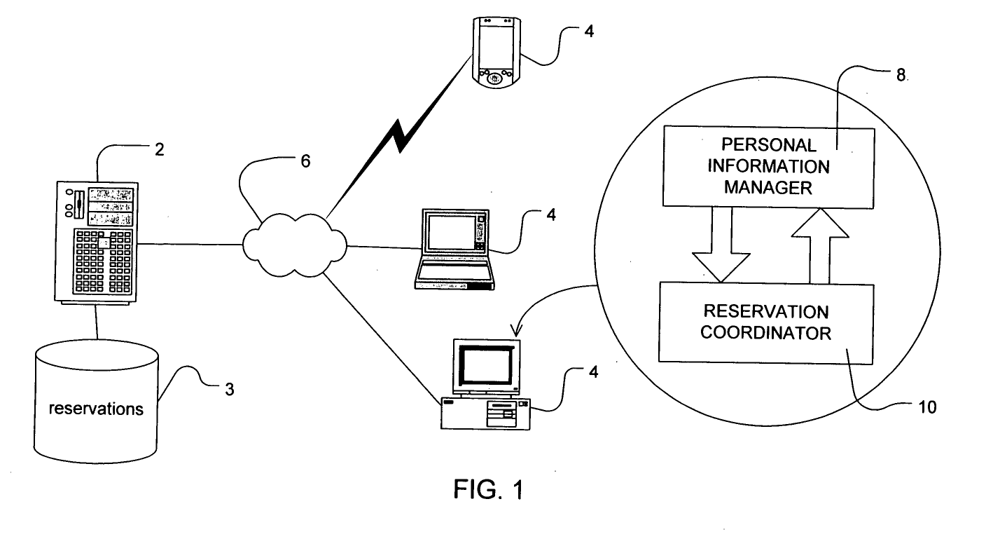

As illustrated in FIG. 1, preferably, a system for achieving the methodology involves a reservation system 2 typically under control of a third party reservation service and one or more client devices each serving as a personal scheduling system 4. Although FIG. 1 illustrates a reservation system 2 having a single server, as those skilled in the art will recognize, the reservation system 2 may typically involve one or more servers. For example, one server with unique communications protocol may be accessed for handling the reservation information, another server with different protocols may be accessed to determine a location of the reservation service where resources may be picked up, i.e., street address of an office, and still another server may be periodically accessed for purposes of updating the version of the software used on the personal scheduling system 2. Specific communications protocols of a preferred implementation of the invention are described in U.S. provisional patent application Ser. No. 60/541,529, the disclosure of which has been incorporated herein by reference.

The reservation system 2 will generally include a communications device for transferring information between one or more client based personal scheduling systems. For example, a server of the reservation system 2 may be equipped with a network communications card coupled to a network 6, such as the Internet. Other modes of communication between the server and the clients may also be implemented. Thus, the reservation system 2 may be at a node of the network and the personal scheduling system at another node.

In general, the reservation system 2 or means for managing reservations, executes routines to manage resources via a reservation service for the many customers or clients of the service desiring to reserve access to the resources of the reservation service. For example, the system would typically include a database 3 containing information about the resources. Thus, in response to a request for availability of reservation resources by a client or customer, the reservation system 2 will check a database for availability of resources of the service. With received information concerning available resources, a client can make a request to reserve the available resource (i.e., create a reservation) to the reservation system 2. The reservation system 2 may then confirm or reject the reservation request in response. A confirmed reservation will result in the reservation system 2 recording scheduling information on the reservation system 2 of the reservation service. Similarly, the reservations system 2 can be queried by a client to confirm that the scheduling information of a pre-existing reservation has or has not changed in the reservation system 2. Generally, the reservation system 2 will also include routines for canceling or changing a pre-existing reservation in the system in response to such a request from a client. For example, a reservation system may be a server managing the scheduling of automobile rentals where the information relating to the availability of the automobiles is stored in a database of the reservation system.

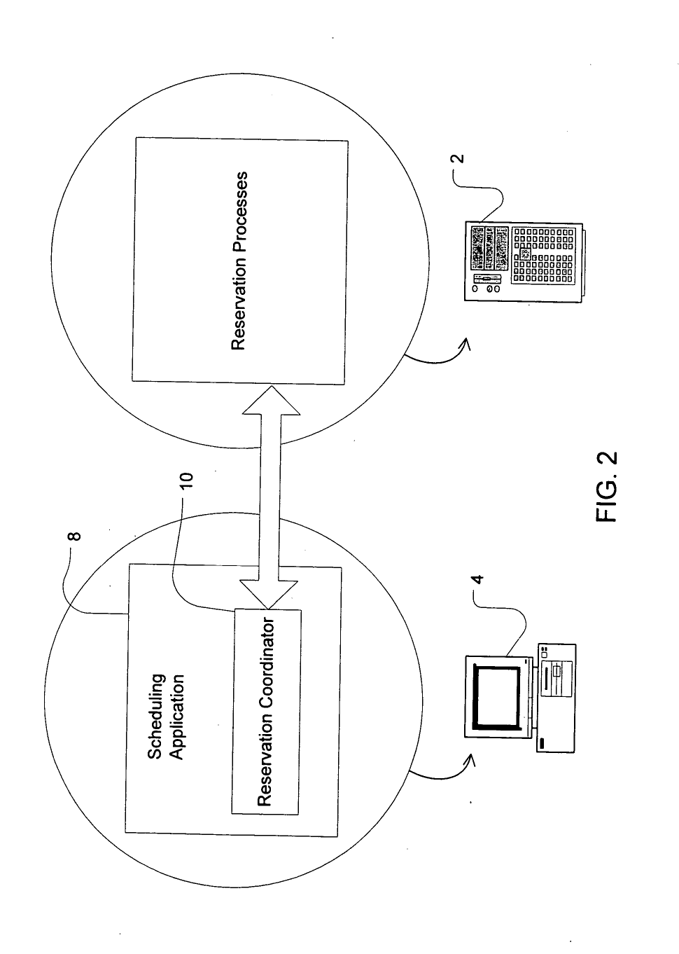

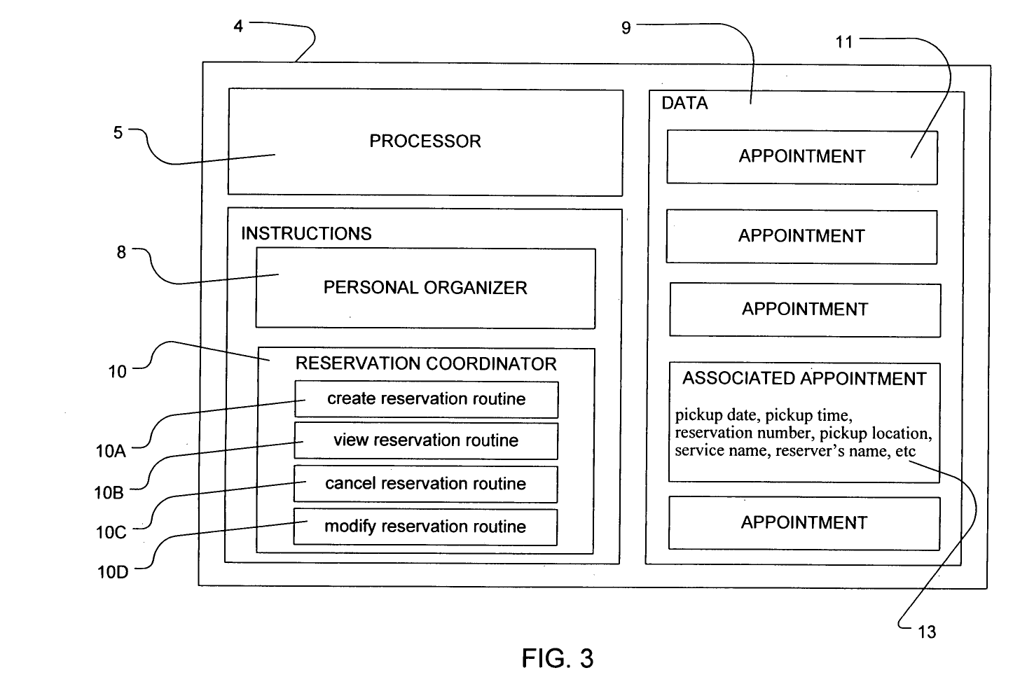

The personal scheduling system 4 may be a personal computer, personal data assistant, laptop or the like operable for communication with the reservation system 2 on the communication system or network. Examples of such personal scheduling systems are illustrated in FIG. 2 and FIG. 3. In general the personal scheduling system 4, or means for managing personal appointment data on a node of the network, will include a communications device, a processor 5 and a scheduling application 8 on the personal scheduling system 4 in which the user of the personal scheduling system may track his or her appointments or events in a calendar. Typically, such an application includes some calendar data structure 9 for storing event/appointment data 11. These appointments may be related and unrelated to any reservation of a reservation service. Thus, the personal scheduling system may be generally used for tracking any kind of appointment or event. The personal scheduling system 4 also includes a reservation coordinator module 10 for controlling the personal scheduling system in coordinating the scheduling information of the reservation system 2 with scheduling information of the scheduling application 8 on the personal scheduling system 4 as described in more detail herein. Generally, the reservation coordinator module will be stored on a machine readable storage medium accessible to the personal scheduling system 4.

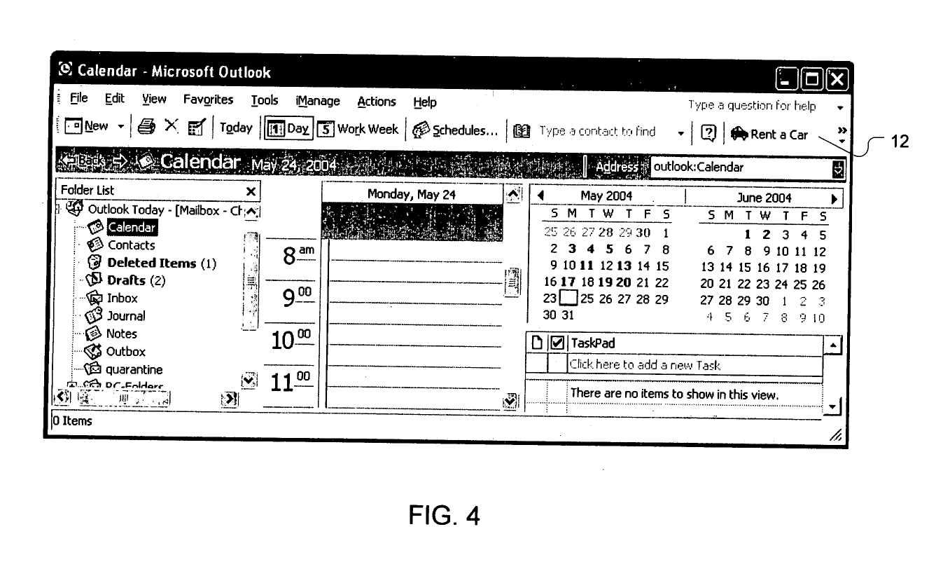

While the reservation coordinator module 10 may be an executable application independent of the scheduling application 8 such that it may be executed on the personal scheduling system 4 without executing the scheduling application 8, in a preferred embodiment, the reservation coordinator module 10 is integrated with the scheduling application 8. For example, the reservation coordinator module 10 may be part of the programming code of the scheduling application. In one embodiment, the scheduling application 8 is the Microsoft Outlook software and the reservation coordinator module 10 is a Microsoft Component Object Model (COM) add-in to Outlook that includes a dynamic-link library (DLL) with control instructions for controlling the processor running a particular operating system to implement the reservation coordinator module 10 and extending the functionality of Outlook. With such integration, the Outlook application itself may include features for launching the reservation coordinator module 10. For example, special menu items may be configured to access the reservation coordinator module 10 or other events associated with the Outlook application interface like drag and drop/selection or change operations on appointments/events in the Outlook application that are specially associated with reservations of a reservation service coordinated by the reservation coordinator module 10. An illustrated embodiment of an interface with a button or initiating prompt 12 for directing a reservation management from the Outlook application is shown in FIG. 4.

Generally, the reservation coordinator module 10 permits the user of the scheduling application 8 to direct the coordination of reservation scheduling information of a reservation service and the scheduling information in the scheduling application 8 through the control of the personal scheduling system by various operations. Preferably, this may be accomplished by its implementation of one or more of a create reservation routine 10A, a view reservation routine 10B, a cancel reservation routine 10C, and a modify reservation routine 10D. The module may be re-used to create, view, cancel or modify any number of reservations with the reservation system. The methodology of each such operation of the reservation coordinator will be described in turn.

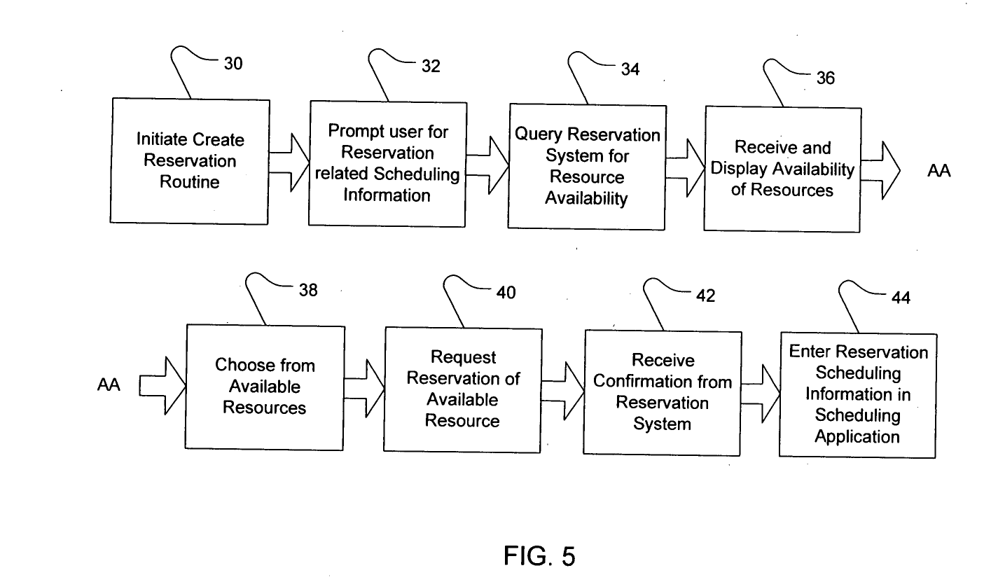

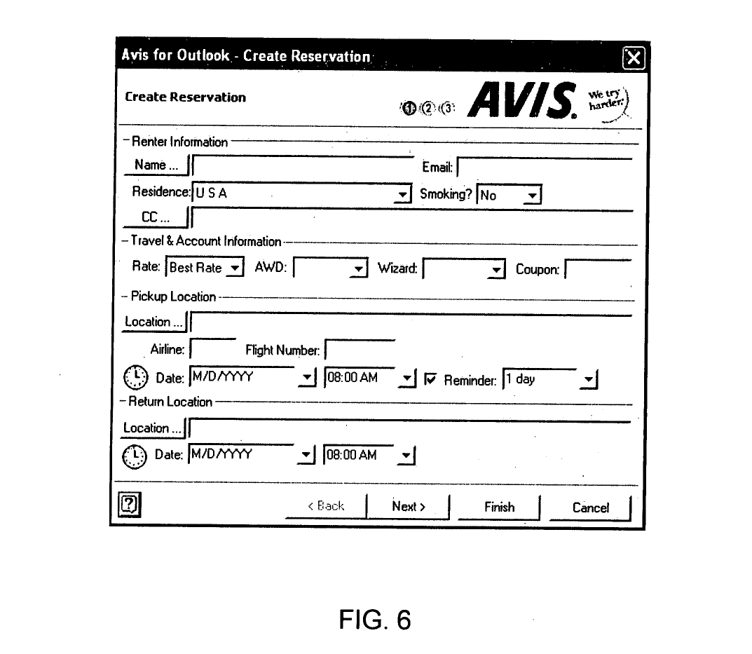

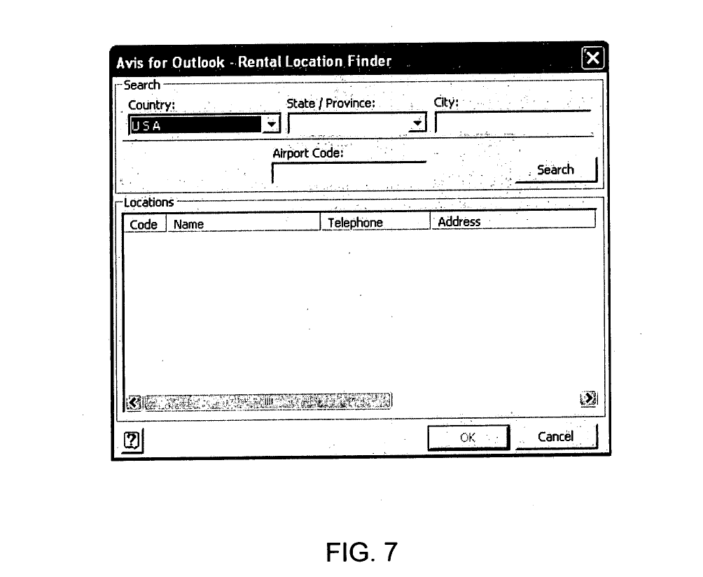

One embodiment of the methodology of the create reservation routine 10A is illustrated in FIG. 5. This routine may be initiated in step 30 on the personal scheduling system 4 when the user selects, for example, a menu item associated with the reservation service. The user in step 32 is then prompted to input reservation related scheduling information associated with the reservation service, preferably without yet connecting with or otherwise requesting information from the reservation system 2. A query interface prompting for input reservation related scheduling information of such a routine with respect to an automobile reservation service is illustrated in FIG. 6. The query interface, which can be generated exclusively by the personal scheduling system 4, includes prompts for such information as name, residence, email address, rate/cost preferences, pick-up and drop off locations, and of course, times and dates. Optionally, the personal scheduling system 4 may request information from the reservation system 2 that may be pertinent to the prompts of the interface, such as finding or searching for a local location for access to the resources of the reservation system. For example, as illustrated in the automobile rental reservation example of FIG. 7, a search interface may be initiated to search for the location of automobile rental location for inclusion in the query interface of FIG. 6.

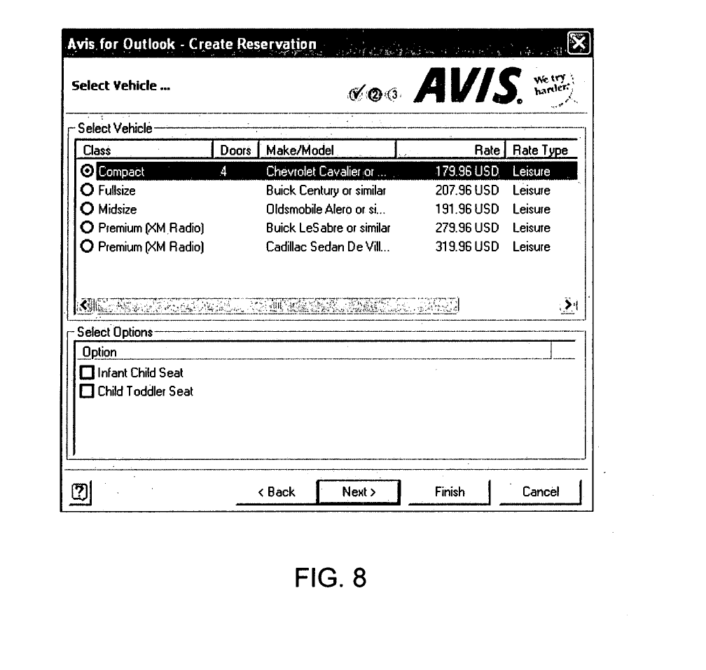

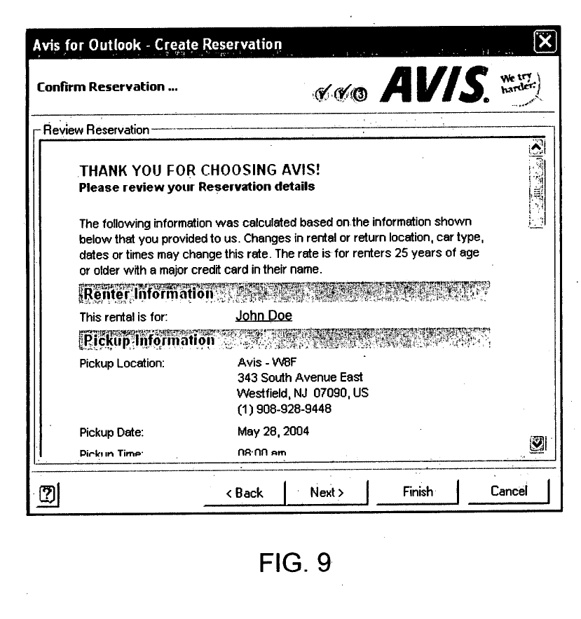

Upon completion of input of the necessary information in the query interface, in step 34, the reservation system 2 is queried by the personal scheduling system 4 for availability of resources of the reservation system 2 as described by the query interface. In step 36, the personal scheduling system 4 receives and displays a response from the reservation system 2, displaying available options with regard to the availability of the resources of the reservation system 2, if any. One embodiment of such a display is illustrated in FIG. 8 showing rate and availability of various automobiles of an automobile rental service. In optional step 38, the user may select from available resources. In step 40, if the user desires the available resource, the personal scheduling system 4 sends a request to the reservation system 2 to reserve the available resource. For example, an interface for initiating such a request in the automobile rental example is illustrated in FIG. 9. In step 42, in response to a successful reservation of the resource by the reservation system 2, the personal scheduling system 3 receives a confirmation from the reservation system 2, confirming the reservation of the available resource. Upon receipt of the confirmation which may then be displayed, in step 44, the create reservation routine of the reservation coordinator module 10 enters reservation associated scheduling information of the confirmation as one or more appointments as necessary in the scheduling application 8. Thus, the reservation scheduling information may be entered into a calendar data structure of the scheduling application 8. Preferably, such associated appointments 13 include an identifier such that they may be recognized as a reservation related appointment by the reservation coordinator module 10, although other schemes may be utilized such that the personal scheduling system may associate the appointment of the scheduling application with a reservation on a reservation system 2. The associated appointment 13 of FIG. 3 illustrates a preferred embodiment of the reservation scheduling information that may be stored in the associated appointment but other embodiments need not include all of this information.

Optionally, one or more messages, e.g., an email message to recipients whose email addresses were selected or entered in the original query interface, may be sent automatically to other scheduling systems from the personal scheduling system that created the reservation at the direction of the reservation coordinator module 10. These messages may be configured to inform others and/or enter scheduling information of the confirmation into the scheduling applications of the other scheduling systems, whether or not the other scheduling applications have a reservation coordinator module 10. This may be accomplished using an option of the scheduling application, such as a new meeting request option of Microsoft's Outlook scheduling application. Such a message will typically include control instructions for the scheduling application to automate creation of the appointments in the calendar data structure 9 of the scheduling application.

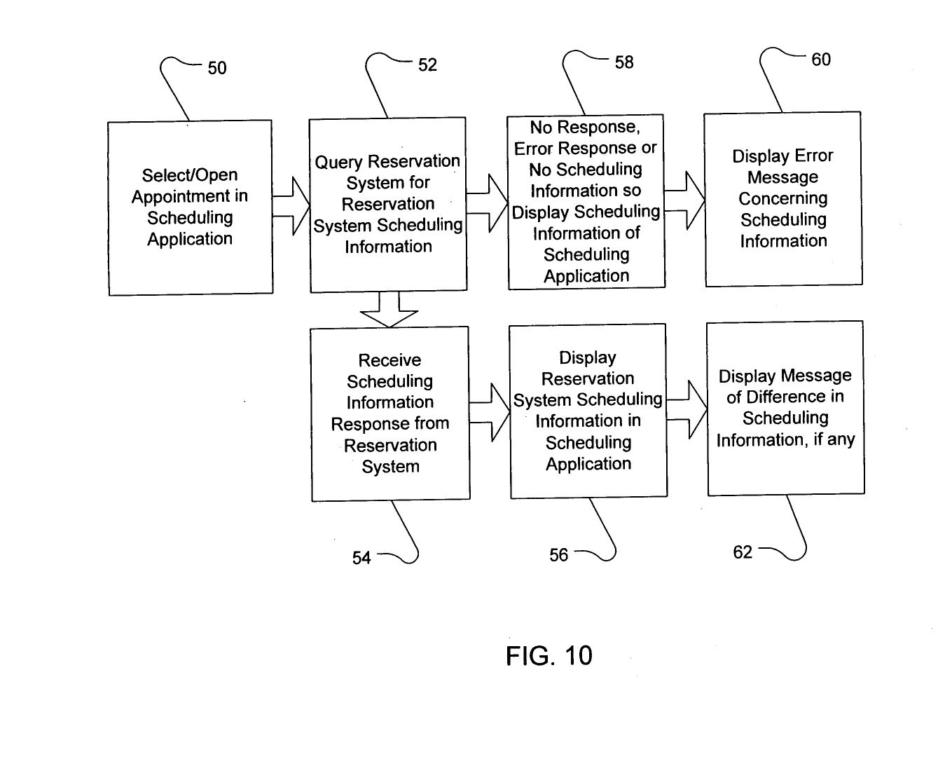

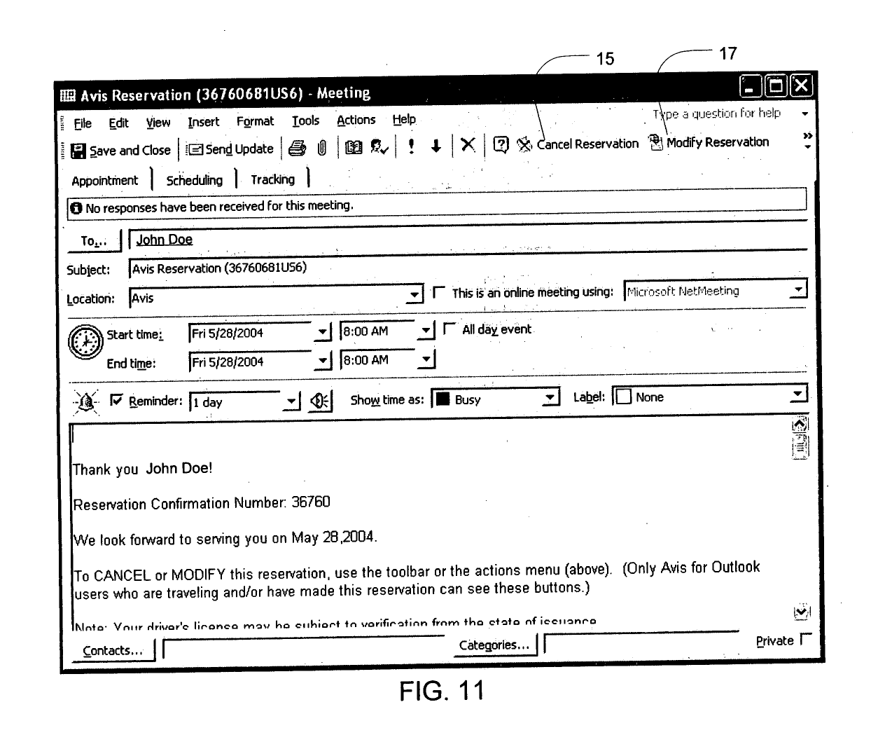

One embodiment of the methodology of the view reservation routine 10B is illustrated in FIG. 10. In this routine or operation, selected associated appointments 13 stored in the scheduling application 8 previously entered by the reservation coordinator module 10, can be displayed. However, in order to coordinate the scheduling information with the reservation system 2, the personal scheduling system preferably displays the reservation scheduling information confirmed from the reservation system 2. Thus, in step 50, the user selects or opens the appointment in the scheduling application for viewing on the personal scheduling system 4. In step 52, the reservation coordinator module 10 recognizes an associated appointment 13 as being related to a reservation on the reservation system and queries the reservation system 2 with respect to the selected reservation. In step 54, the reservation coordinator module 10 receives a response to the query. In step 56, the reservation coordinator module 10, displays the scheduling information received from the reservation system 2 with the scheduling application 8, if it is received. In step 58, if no scheduling information is received from the reservation system 2 (e.g., if no communication is possible, if no reservation exists in the reservation server, if some other error response is received, if no response is received, etc.), the reservation coordinator module 10 displays the scheduling information from the scheduling application 10 and notifies the user of the error in step 60. In step 62, if the scheduling information received from the reservation system 2 differs from the scheduling information of the scheduling application, the reservation coordinator module 10 notifies the user of the change or difference. One embodiment of a display interface to show the scheduling information of the scheduling application or received from the reservation system 2 is illustrated in FIG. 11. In this way, changes with regard to the reservation on the reservation system 2 are also changed in the organizer application of the personal scheduling system 4.

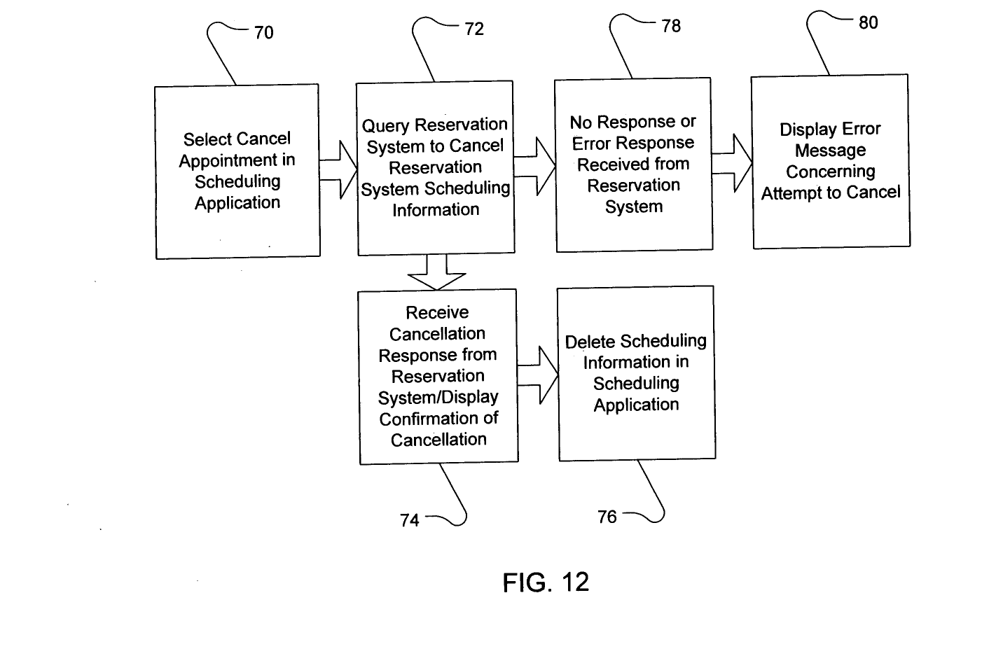

One embodiment of a methodology of the cancel reservation routine 10C for canceling a reservation is illustrated in FIG. 12. When a user of the scheduling application 8 desires to cancel a reservation with scheduling information stored in the scheduling application 8, the associated appointment 13 for cancellation may be selected for viewing as described previously. Alternately, it may be selected for deletion without viewing. In step 70, a cancel operation is selected/initiated with respect to the appointment to be cancelled in the scheduling application 8, for example, by selecting a cancel prompt 15 or another button associated with the cancellation operation. In step 72, the reservation coordinator module 10 queries the reservation system to cancel the particular reservation associated with the appointment of the scheduling application 8. In response, in step 74, the personal scheduling system 4 receives a cancellation response, which may optionally be displayed to the user, confirming that the reservation system 2 has cancelled the reservation. Thereafter, the reservation coordinator module 10 may delete the scheduling information in the scheduling application 8 in step 76. Alternatively, the scheduling information can be left in the scheduling application but modified so as to indicate the reservation has been cancelled on the reservation system 2. In step 78 no response may be received from the reservation system 2 or an error response is received, for example, if the reservation system 2 does not or can not confirm cancellation. If so, in step 80, an error notice may be displayed by the reservation coordinator module 10 with the scheduling application 8. Such a step may include optionally deleting the scheduling information in the scheduling application 8 or maintaining such information until a later repeated delete operation is successful with the reservation system 2. Similar to the methodology at the conclusion of the create routine previously discussed, the reservation coordinator module 10 may be further configured to control sending of email messages to notify other users of other personal scheduling systems of the cancellation or to cancel the appointment in the other personal scheduling systems.

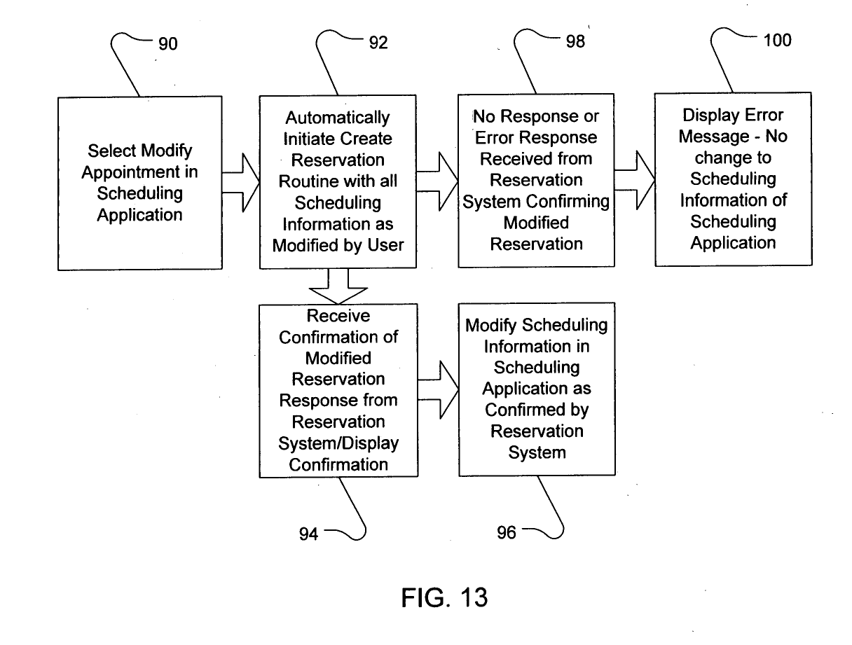

Preferably, any attempt by the user of the scheduling application to modify reservation scheduling information entered by the reservation coordinator module 10 in an appointment of the scheduling application will initiate a modify routine of the reservation coordinator module 10. Methodology for one such function is shown in FIG. 13. As illustrated, from a selected or viewed reservation appointment according to the methodology as previously described, the user may select modify appointment in the scheduling application in step 90, for example, by selecting a modify prompt 17 or other button associated with the modify operation. In step 92, the create reservation routine, like that described with reference to FIG. 3, may be initiated automatically with the existing scheduling information of the reservation system 2, which may be modified by the user in a query interface like that of FIG. 6. In this step, like the create routine, steps 32-40 will be performed as described with respect to FIG. 3. In step 94, a confirmation of the modified reservation is received from the reservation system 2, which may then be displayed on the personal scheduling system 4. In step 96, the modified scheduling information confirmed from the reservation system 2 is entered in the scheduling application and the original reservation is cancelled. In this step, cancellation of the original reservation may automatically occur according to the cancel routine previously described with regard to FIG. 12 resulting in the coordinated removal of the scheduling information from the original reservation in both the reservation system 2 and the scheduling application 8 of the personal scheduling system 4. In step 98 no confirmation response from the reservation system 2 is received or an error response is received with regard to the modification of step 92. In this event, a message is displayed in step 100 describing the error and no change is made to the scheduling information of the scheduling application by the reservation coordination routine. Of course, the modify routine may alternatively be accomplished more directly with a modify request that changes the reservation data on reservation system 2 without performing distinct cancel and create operations.

With use of such a system, a reservation coordinator module 10 may be widely distributed to customers of a reservation service to simplify their access to the resources of the reservation service. It provides each customer/user with a greater degree of control to direct the coordination of the external reservation scheduling information of another system that is also managed in the personal scheduling system of the customer/user. Moreover, by integrating the functionality with the user's personal scheduling application, the number of steps required by the user is reduced making organization of scheduling information much simpler. For example, a user no longer would need to open a browser and access the web site of a reservation system in order to create or modify reservations. Moreover, the user will no longer need to create personal scheduling information separately in the user's personal organizer/scheduling application and the reservation system.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for integrating reservation information with personal information management information comprising:
providing control instructions for a processor and data at a first node of a network, the control instructions including instructions for managing appointments and instructions for storing data associated with appointments;
providing a reservation system with reservation data stored at a second node of the network;
creating appointment data and reservation data such that when a reservation is created, at least a portion of information associated with the reservation is stored at the first node as associated appointment data and also at the second node as reservation data;
modifying the associated appointment data at the first node to cause a change to the associated appointment data and the reservation data at both nodes; and
modifying the reservation data at the second node to cause a change to the associated appointment data and the reservation data at both nodes.

2. The method of claim 1 wherein the reservation data comprises rental automobile information.

3. The method of claim 2 wherein the network is an internet.

4. The method of claim 3 wherein the processor is a component of a personal computer.

5. The method of claim 4 wherein the control instructions comprise an add in component of a calendar program.

6. The method of claim 5 wherein the calendar program is Microsoft Outlook.

7. The method of claim 1 wherein the control instructions of the first node control synchronously viewing of the associated appointment of the first node by confirming reservation data from the second node.

8. The method of claim 7 wherein the control instructions of the first node control synchronously viewing of the associated appointment by displaying the reservation data from the second node.

9. The method of claim 1 wherein the control instructions of the first node control synchronously canceling of the associated appointment of the first node by confirming cancellation of reservation data from the second node.

10. The method of claim 1 wherein the control instructions of the first node control synchronously modifying of the associated appointment of the first node by requesting a reservation data change by the system of the second node and confirming the change of reservation data from the second node.

11. A system for integrating reservation information with personal information management information comprising:
a means for managing customer reservation data on a first node of a network;
a means for managing personal appointment data on a second node of the network; and
reservation coordinator instructions to automate synchronization of personal appointment data associated with customer reservation data, the reservation coordinator instructions at the second node, the reservation coordinator instructions being configured to associate personal appointment data at the second node, with customer reservation data of the first node;
wherein reservation coordinator instructions create associated appointment data at the second node and reservation data at the first node such that when a reservation is created, at least a portion of information associated with the reservation is stored at the second node as associated appointment data and also at the first node as reservation data.

12. The system of claim 11 wherein the reservation coordinator instructions synchronously modifies the associated appointment data at the second node to cause a change to the associated appointment data and the reservation data at both nodes.

13. The system of claim 12 wherein the reservation coordinator synchronously modifies the reservation data at the first node to cause a change to the associated appointment data and the reservation data at both nodes.

14. The system of claim 13 wherein the reservation data comprises rental automobile information.

15. The system of claim 14 wherein the network is an internet.

16. The system of claim 15 wherein the means for managing personal appointment data includes a personal computer coupled to the network.

17. The system of claim 16 wherein the reservation coordinator instructions comprise an add in component of a calendar program.

18. The system of claim 17 wherein the calendar program is Microsoft Outlook.

19. The system of claim 11 wherein the reservation coordinator instructions control synchronously viewing of the associated appointment of the second node by confirming reservation data from the first node.

20. The system of claim 19 wherein the reservation coordinator instructions of the second node control synchronously viewing of the associated appointment by displaying the reservation data from the first node.

21. The system of claim 11 wherein the reservation coordinator instructions of the second node control synchronously canceling of the associated appointment of the second node by confirming cancellation of reservation data from the first node.

22. The system of claim 11 wherein the reservation coordinator instructions of the second node control synchronously modifying of an associated appointment of the second node by requesting a reservation data change to the first node and confirming the change of reservation data from the first node.

23. A method for coordinating the reservations of a reservation system with the scheduling information of a personal organizer running on a user's system comprising the steps of:
accessing a reservation coordinator for controlling a user's system, the reservation coordinator configured on the user's system to enable a user to direct scheduling of reservations with a reservation system through a communications link from the user's system and further configured to store scheduling information of the reservation system in a personal organizer of the user's system;
communicating through the communications link a scheduling request for reserving a resource tracked by the reservation system, the scheduling request initiated under the control of the reservation coordinator in response to user input on the user's system;
receiving through the communications link a reservation confirmation from the reservation system relating to the scheduling request; and
storing scheduling information of the reservation confirmation as an associated appointment in a personal organizer of the user's system under the control of the reservation coordinator.

24. The method of claim 23 wherein the reservation coordinator is integrated in the personal organizer of the user's system.

25. The method of claim 24 wherein the reservation coordinator is an add in component of the personal organizer.

26. The method of claim 25 wherein the reservation system is an automobile rental service and the scheduling information includes information associated with renting an automobile including the time and date of pickup.

27. The method of claim 23 further comprising the step of canceling a reservation of the reservation system under the control of the reservation coordinator, wherein the step of canceling comprises the sub-steps of:
requesting cancellation of a reservation of the reservation system through the communications link in response to a user selecting cancellation of an associated appointment in the personal organizer on the user's system;
receiving through the communications link confirmation of cancellation of the reservation by the reservation system; and
modifying or removing the associated appointment of the personal organizer on the user's system to reflect cancellation on the reservation system.

28. The method of claim 27 further comprising the step of modifying a reservation of the reservation system under the control of the reservation coordinator, wherein the step of modifying the reservation comprises the sub-steps of:
sending a modified scheduling request through the communications link to the reservation system, the scheduling request including modified scheduling information entered by a user in response to a user selecting a modification operation with respect to an associated appointment in the personal organizer on the user's system,
receiving through the communications link a reservation confirmation from the reservation system relating to the modified scheduling request;
storing scheduling information of the reservation confirmation as an associated appointment in a personal organizer of the user's system;
requesting cancellation of a previous reservation of the reservation system through the communications link, the previous reservation relating to the associated appointment in the personal organizer on the user's system from which the user selected the modification operation,
receiving through the communications link confirmation of cancellation of the previous reservation by the reservation system; and
removing an associated appointment of the personal organizer on the user's system to reflect cancellation of the previous reservation on the reservation system.

29. The method of claim 23 further comprising the step of controlling viewing of the scheduling information of an associated appointment of the personal organizer on the user's system under control of the reservation coordinator, wherein the step of viewing comprises the sub-steps of:
querying the reservation system through the communications link for scheduling information of the reservation system in response to a user selecting an associated appointment in the personal organizer on the user's system;
receiving scheduling information through the communications link from the reservation system relating to the associated appointment; and
displaying received scheduling information of the reservation system from the associated appointment.

30. The method of claim 29 wherein the step of viewing further comprises the sub-step of displaying scheduling information of the personal organizer from the associated appointment in the absence of receiving scheduling information of the reservation system through the communications link from the reservation system.

31. The method of claim 23 further comprising the step of automatically sending one or more email messages to selected users of other personal organizers under the control of the reservation coordinator, the email messages including control instructions for automating entering of the scheduling information of the reservation system into the other personal organizers of the selected users.

32. A medium for storing processor control instructions for a computer or the like, the medium including a reservation coordinator module with processor control instructions for coordinating reservations of a reservation system with scheduling information of a personal organizer application of a personal scheduling system, the reservation coordinator module comprising:
a user interface with a prompt to enable a user to selectably initiate a request for a reservation to schedule resources managed by a reservation system, the user interface integratable with a personal organizer application for generally organizing scheduling information of a user, the personal organizer application having a calendar data structure;
a create routine responsive to the user interface, the create routine for sending requests for reservations of resources available to the reservation system and for receiving a confirmation response with reservation scheduling information for the available resources, the request and response communicated via an accessible communications device,
a store operation responsive to the confirmation response of the create routine, the store operation for placing the reservation scheduling information of the reservation system as an associated appointment in the calendar data structure of the personal organizer application;
whereby the reservation coordinator module enables a user of the personal organizer application running on a personal scheduling system to direct scheduling of resources of the reservation system from the personal organizer application and automating entry of the reservation scheduling information from the reservation system in the personal organizer application.

33. The medium of claim 32 wherein the reservation coordinator module is an add in component for the personal organizer application.

34. The medium of claim 33 wherein the reservation system is an automobile rental service and the reservation coordinator module is configured to send the requests to a server of the reservation system of the automobile rental service with the requests configured to include automobile information.

35. The medium of claim 32 wherein the reservation coordinator module further comprises a canceling routine for canceling a reservation of the reservation system, the canceling routine including instructions for controlling:
communicating a request for cancellation of a reservation of the reservation system in response to a user selecting cancellation of an associated appointment in the calendar data structure of the personal organizer application;
receiving a communicated confirmation of cancellation of the reservation of the reservation system; and
modifying or removing the associated appointment of the calendar data structure of the personal organizer application to reflect cancellation by the reservation system.

36. The medium of claim 35 wherein the reservation coordinator module further comprises a modify routine for modifying a reservation of the reservation system and an associated appointment of the personal organizer application.

37. The medium of claim 36 wherein the modify routine comprises instructions for controlling:
communicating a modified scheduling request to the reservation system, the scheduling request including modified scheduling information entered by a user in response to a user selecting a modification prompt with respect to an associated appointment in the data structure of the personal organizer application,
receiving a communicated reservation confirmation from the reservation system relating to the modified scheduling request;
storing scheduling information of the reservation confirmation as an associated appointment in the data structure of the personal organizer application;
communicating a request for cancellation of a previous reservation of the reservation system, the previous reservation relating to the associated appointment in the personal organizer on the user's system from which the user selected the modification prompt,
receiving a communicated confirmation of cancellation of the previous reservation by the reservation system; and
removing an associated appointment from the data structure of the personal organizer application to reflect cancellation of the previous reservation on the reservation system.

38. The medium of claim 32 wherein the reservation coordinator module further comprises a viewing routine, the viewing routine for controlling viewing of the scheduling information of an associated appointment of the data structure of the personal organizer application, the viewing routine comprising instructions for controlling:
communicating a query of the reservation system for scheduling information of the reservation system in response to a user selecting an associated appointment of the data structure of the personal organizer application;
receiving communicated reservation system scheduling information from the reservation system relating to the associated appointment; and
displaying the communicated reservation system scheduling information from the reservation system.

39. The medium of claim 38 wherein the viewing routine further comprises instructions for controlling displaying of scheduling information of the data structure of the personal organizer application from the associated appointment in the absence of receiving communicated reservation system scheduling information from the reservation system.

40. The medium of claim 32 wherein the reservation coordinator module further comprises instructions for controlling automatically sending one or more email messages from the personal organizer application to selected users of other personal organizer applications, the email messages including control instructions for automating entering of the scheduling information of the reservation system into the data structures of the other personal organizer applications.

41. A system for controlling coordinating of reservation scheduling information of a reservation service and personal scheduling information of a personal organizer comprising:
a reservation system for managing and scheduling availability of resources of a reservation service for a plurality of users of the resources of the reservation service, the reservation system coupled to a communications network to receive requests and send responses over the communications network, the requests and responses relating to managing and scheduling of the resources;
an integratable reservation coordinator configured for integration with a personal organizer application that manages a user's appointments, the appointments relating to events associated with a reservation of the reservation system and other events not associated with the reservation system, the personal organizer application and reservation coordinator to be executed on a user's personal scheduling system accessible to the communications network;
wherein the reservation coordinator is further configured with operations to enable a user of the personal organizer application to direct coordination of reservations of the reservation system by communicating automated requests to the reservation system for creating or deleting reservations, the operations initiated by a user of an interface of the personal organizer application, the reservation coordinator further configured with automated operations to enter or remove an appointment associated with a reservation of the reservation system, the automated enter or remove operations changing a calendar data structure of the personal organizer application to coordinate a change made in the reservation system in conjunction with requests made by the reservation coordinator.

42. The system of claim 41 wherein the reservation service is an automobile rental service and the reservation system includes a database configured with rental automobile information.
